(19) United States
(12) Patent Application Publication
(10) Pub. No.: US 2012/0136963 A1
(43) Pub. Date: May 31, 2012

(54) CONTENT TRANSMISSION METHOD, CONNECTION-TARGET STORAGE, AND CONTENT TRANSMISSION PROGRAM

(75) Inventor: Satoru GOTO, Nagoya-shi (JP)

(73) Assignee: Buffalo Inc., Nagoya-shi (JP)

(21) Appl. No.: 13/286,511

(22) Filed: Nov. 1, 2011

(30) Foreign Application Priority Data
Nov. 1, 2010 (JP) 2010-245148

(51) Int. Cl. G06F 15/16

(52) U.S. Cl. 709/217

(57) ABSTRACT

A content transmission method includes: a step in which a client device transmits a partner list request to a connection-target storage; a step in which the connection-target storage transmits the partner list request to a partner storage; a step in which a partner storage transmits a partner content list that is a list of contents in the partner storage, to the connection-target storage; a step in which the connection-target storage transmits the partner content list to a client device; and a step in which the client device transmits a data transmission request including transmission-source information indicating a content that is selected based on the partner content list and that is transmitted to the connection-target storage, to the connection-target storage.

### CROSS REFERENCE TO RELATED APPLICATION

This application is based upon and claims the benefit of priority from prior Japanese Patent Application No. 2010-245148, filed on Nov. 1, 2010 the entire content of which is incorporated herein by reference.

### BACKGROUND OF INVENTION

1. Field of Invention

The present invention relates to a content transmission method in which content data is transmitted among a plurality of storages, a connection-target storage, and a content transmission program.

2. Description of Related Art

In recent years, with the glowing use of digital contents, such as images and sounds, it is desired to share the digital content among a plurality of storages as well as storing the digital content in a user's own machine and using it.

For example, a content is stored in a storage (e.g., NAS: Network Attached Storage) connected to a network such as Internet, a user accesses the storage via the network from a PC, etc., and the content in the storage is used in the PC.

Along with the glowing popularity of digital contents, it is required to replicate and move digital contents among a plurality of storages. For example, in order to replicate a content, a user accesses a storage containing the content to be replicated (hereafter referred to also as “replica-source storage”) by a client device (e.g., PC) to acquire the content in this storage. Subsequently, the user accesses a storage to which the content is to be sent (hereafter referred to also as “replica-target storage”) by the client device, to replicate the content acquired from the replica-source storage, into the replica-target storage. That is, the client device relays the content data between the replica-target storage and the replica-source storage. According to such a data replicating method, the operating load on the client device increases. In particular, when a mobile terminal such as a smart phone is used as the client device, reduction in available operating time, arising from consumption of a battery, may be conspicuous.

In view of such a problem, a system has been proposed in which the content is replicated among a plurality of storages without the intervention of the client device (e.g., see Japanese Unexamined Patent Application Publication No. 2004-5189). In the proposed system, the client device transmits a request for replicating a content, to the source storage. In the replica request, the content data is specified. In response to the list request, the replica-source storage transmits the data that is stored in the replica-source storage and required by the replica request, to the replica-target storage.

### SUMMARY OF THE INVENTION

The replica-source storage that has received a replica request from the client device transmits data to the replica-target storage that is a partner device. However, it is not assumed that the replica-source storage acquires the data from the replica-target storage. Further, the client device has not acquired a content list from the replica-target storage, and thus, the client device cannot transmit the replica request requesting the transmission of the data from the replica-target storage to the replica-source storage.

The present invention has been achieved in view of the above-described circumstances, and objects of the invention is to provide a content transmission method in which when a client device accesses a connection-target storage, content data can be transmitted to a connection-target storage from a partner storage connected via a network to the connection-target storage, to provide a connection-target storage, and to provide a content transmission program.

According to a first aspect of the present invention, there is provided a content transmission method in which a partner storage connected to a connection-target storage via a network transmits content data to the connection-target storage connected to a client device via a network, including: a step in which the client device transmits a partner list request requesting a partner content list that is a list of contents stored in the partner storage, to the connection-target storage; a step in which the connection-target storage transmits the partner list request, to the partner storage; a step in which the partner storage transmits the partner content list to the connection-target storage, in response to the partner list request; a step in which the connection-target storage transmits the partner content list received from the partner storage, to the client device; and a step in which the client device transmits a data transmission request including transmission-source information indicating a transmission source storing the content selected based on the partner content list, to the connection-target storage.

According to this content transmission method, a connection-target storage acquires a partner content list from a partner storage, in response to a partner list request, and this partner content list is transmitted to a client device. Therefore, the client device can acquire the partner content list via the connection-target storage.

The client device need not directly access the partner storage, but it suffices that the client device can access the connection-target storage. Therefore, even when the client device cannot directly access the partner storage, e.g. when access to the partner storage from the client device is restricted, or when the client device does not acquire the address (e.g., IP address) of the partner storage, the client device can acquire the partner content list.

Thus, when the client device acquires the partner content list, it becomes possible to select a content to be replicated or moved t from the partner content list and it is possible to transmit a data transmission request including transmission-source information indicating the partner content selected from the partner content list. Therefore, if the client device accesses the connection-target storage, the partner storage can transmit the partner content data to the connection-target storage from the partner storage.

It is noted that regarding the transmission of the partner content data from the partner storage to the connection-target storage, the partner content data may simply be copied (data still remain in the transmission source), or may be removed (data is deleted from the transmission source). Moreover, the client device and the connection-target storage may be arranged in the same segment, or in different segments which are connected via a relay server, for example.

It is noted that the “content” includes not only digitalized image and audio but also a text file and a data file such as a Word file and Excel file. The content list may have a tree-like structure in which a plurality of items are hierarchized. For example, the content list may indicate content names, or the names of folders in which contents are stored.

A content transmission method may include: a step in which the client device transmits a connection-target list request requesting a connection-target content list that is a list of contents stored in the connection-target storage, to the connection-target storage; a step in which the connection-target storage transmits the connection-target content list to the client device, in response to the connection-target list request; and a step in which the client device transmits data transmission request including transmission-source information indicating a transmission source of the content selected based on the connection-target content list and transmission-target information indicating a destination for the content, to the connection-target storage.

The content transmission method may further include: a step in which the partner storage designates a transmission target based on the transmission-target information when a partner content in the partner storage is included in the transmission-source information, and transmits the corresponding partner content data to the connection-target storage.

Thus, when the connection-target storage is so designed as to transmit the connection-target content list to the client device, in response to the connection-target list request, the client device can acquire the connection-target content list and the partner content list. Therefore, the t partner content data can be transmitted from the partner storage to the connection-target storage and in addition thereto, the e connection-target content data can be transmitted from the connection-target storage to the partner storage.

The content transmission method may further include: a step in which the partner storage designates a transmission target based on the transmission-target information and transmits the partner content data to the connection-target storage, when a partner content stored in the partner storage is included in the transmission-source information.

The content transmission method may further include: a step in which the connection-target storage designates a transmission target based on the transmission target information and transmits the corresponding connection-target content data to the partner storage, when a connection-target content stored in the connection-target storage is included in the transmission source information.

The connection-target storage may include: a step in which the connection-target storage transmits a name resolution request to acquire the address of the partner storage, to a name resolution server configured to execute a name resolution with the partner storage, in response to the partner list request; and a step in which the name resolution server transmits the address of the partner storage as a name resolution result, to the connection-target storage, in response to the name resolution request.

According to a second aspect of the present invention, there is provided a connection-target storage, including: a storage unit for storing therein a plurality of contents; and a communication unit for communicating with a client device and a partner storage via a network, wherein the communication unit receives a partner list request requesting a partner content list stored in the partner storage, from the client device, receives the partner content list from the partner storage, in response to the partner list request, transmits the partner content list to the client device, and receives a data transmission request including transmission-source information indicating a partner content selected based on the partner content list, from the client device.

The connection-target storage may further include a processing unit for creating a connection-target content list stored in the connection-target storage, and the communication unit receives the partner list request and a connection-target list request requesting the connection-target content list, from the client device, and transmits the connection content list and the partner content list, to the client device.

Further, the connection-target storage according to the present invention may further include a record holding unit for temporarily recording the partner content list. In such a case, the connection-target storage can transmit the partner content list recorded in the record holding unit to the client device without acquiring the partner content list at the time of each reception of the partner list request, and thus, it is possible to shorten processing time. For example, when the speed of a network connecting the partner storage and the connection-target storage is relatively slow, it is possible to shorten processing time as compared with the case in which a partner content list is acquired via a network.

According to a third aspect of the present invention, there is provided a content transmission program that causes a computer that can communicate with a partner storage and a client device via a network to function as: a list request reception means for receiving a partner list request requesting a partner content list stored in the partner storage, from the client device via a network; a list transmission and reception means for transmitting the partner list request to the partner storage, and transmitting the partner content list received from the partner storage, to the client device; and a data transmission request reception means for receiving a data transmission request including information indicating a partner content selected based on the partner content list, from the client device.

According to the present invention, the client device can acquire a partner content list via the connection-target storage by accessing the connection-target storage.

Therefore, it becomes possible to select the partner content to be replicated or moved, from in the partner content list and thus, it is possible to transmit a data transmission request including transmission-source information indicating the selected partner content. Thus, when the client device accesses the connection-target storage, the partner content data can be transmitted from the partner storage to the connection-target storage.

### BRIEF DESCRIPTION OF DRAWINGS

FIG. 1 is a block diagram illustrating the configuration of a content transmission system according to a first embodiment.

FIG. 2 is a configuration diagram of a first NAS illustrated in FIG. 1.

FIG. 3 is a configuration diagram of a second NAS illustrated in FIG. 1.

FIG. 4 is a configuration diagram of a mobile terminal illustrated in FIG. 1.

FIG. 5 is a configuration diagram of a management server illustrated in FIG. 1.

FIG. 6 is a sequence chart illustrating an operation of the content transmission method according to the first embodiment.

FIG. 7 is a flowchart illustrating an authentication process of the content transmission method according to the first embodiment.

FIG. 8 is a flowchart illustrating a replica permission determination process of the content transmission method according to the first embodiment.

FIG. 9 is a sequence chart illustrating an operation of the content transmission method according to the first embodiment.

FIG. 10 is a sequence chart illustrating an operation of a content transmission method according to a second embodiment.

FIG. 11 is a sequence chart illustrating an operation of the content transmission method according to the second embodiment.

### DESCRIPTION OF EMBODIMENTS

### First Embodiment

With reference to the drawings, a first embodiment of the present invention will be described. Specifically, (1) brief configuration of content transmission system, (2) configuration of first NAS 10, (3) configuration of second NAS 20, (4) configuration of mobile terminal 30, (5) configuration of management server 40, and (6) content transmission method will be described.

(1) Brief Configuration of Content Transmission System

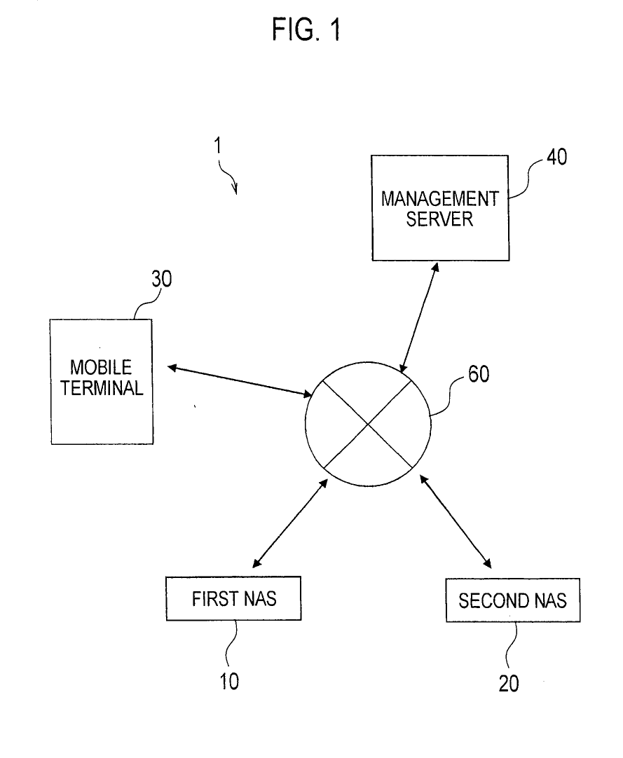

FIG. 1 is a block diagram illustrating the configuration of a content transmission system 1 that realizes a content transmission method according to the first embodiment. The content transmission system 1 includes a first NAS 10 as a connection-target storage, a second NAS 20 as a partner storage, a mobile terminal 30 as a client device, and a management server 40 as a name resolution server. The first NAS 10, the second NAS 20, and the management server 40 are connected to one another via a network (e.g., Internet) 60. The mobile terminal 30 is connected to the first NAS 10 and the management server 40 via the network (including a mobile telephone network and a gateway) 60.

The content transmission system 1 is a system in which content data stored in the first NAS 10 is replicated or moved to the second NAS 20 in response to a replica request as data transmission request from the mobile terminal 30, and content data stored in the second NAS 20 is replicated or moved to the first NAS 10 in response to a replica request from the mobile terminal 30.

The first NAS 10 is a connection-target storage in the present invention. A first content stored in the first NAS10 corresponds to a connection-target content, and the list of the first contents corresponds to the connection-target content list. A first list request for the first content list corresponds to a connection-target list request.

The second NAS 20 is a partner storage in the present invention. A second content stored in the second NAS20 corresponds to a partner content, and the list of the second contents corresponds to the partner content list. A second list request for the second content list corresponds to a partner list request.

The management server 40 stores the device name of each NAS and its associated IP address, transmits the IP address of NAS to another NAS or the mobile terminal 30 in response to a name resolution request from each NAS or the mobile terminal 30, and executes a name resolution.

One NAS, for example, that has acquired the IP address become capable of directly accessing the other NAS (without the intervention of the management server 40), and as a result, a connection between the NAS's is established (hereinafter, referred to as “Web access function”).

Thus, the management server 40 functions as a relay between a NAS and another device so that such a device as a mobile phone or a PC can access the internal content of each NAS via the Internet so as to effectuate the download and upload of contents.

The first NAS 10 and the second NAS 20 are predetermined as to whether or not a Web access to them is permitted, and if permitted, accessible contents are preselected. By accessing from the mobile terminal 30 to the management server 40, it is possible to acquire, by the Web access function, the first content list and the second content list.

(2) Configuration of First NAS 10

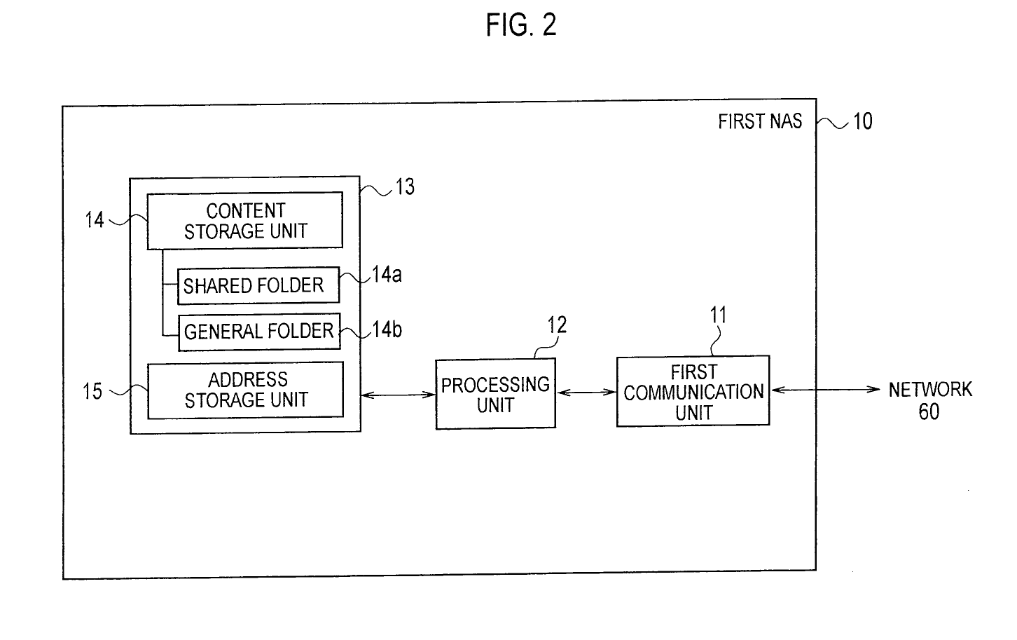

The configuration of the first NAS 10 as a connection-target storage will be described below with reference to FIG. 2. FIG. 2 is a configuration diagram of the first NAS 10. The first NAS 10 includes a first communication unit 11, a processing unit 12, and a first storage unit 13.

The first communication unit 11 is an interface for connecting the first NAS 10 to WAN. When it is configured such that the first NAS 10 is connectable also to LAN, the configuration may be such that a LAN port or a wireless LAN port for connecting to LAN is provided. The first communication unit 11 functions as a list request reception means, a list transmission and reception means, and a data transmission request reception means.

The processing unit 12 executes a process in response to the replica request, the first list request, and the second list request received via the first communication unit 11. The processing unit 12 acquires the first list request, etc., via the first communication unit 11. The processing unit 12 creates a first content list, for example, in response to the first list request. The processing unit 12 acquires the replica request for selecting the transmission-target information and the transmission-source information, via the first communication unit 11. The processing unit 12 creates a replica content, with reference to the first content stored in the first storage unit 13, in response to the replica request, and stores the second content acquired from the second NAS 20, based on the transmission-target information, for example.

The first storage unit 13 may be any type of nonvolatile storing means such as HDD (Hard Disk Drive) or SSD (Solid State Drive) in which predetermined information is stored. The storage unit 13 includes a content storage unit 14 and an address storage unit 15. The content storage unit 14 stores a digital content such as audio and video contents. The content storage unit 14 includes a shared folder 14a in which a content permitting a Web access from outside is stored, and a general folder in which a content restricting the Web access is stored. The address storage unit 15 stores an address table that relates device names of connectable devices to their associated IP addresses.

(3) Configuration of Second NAS 20

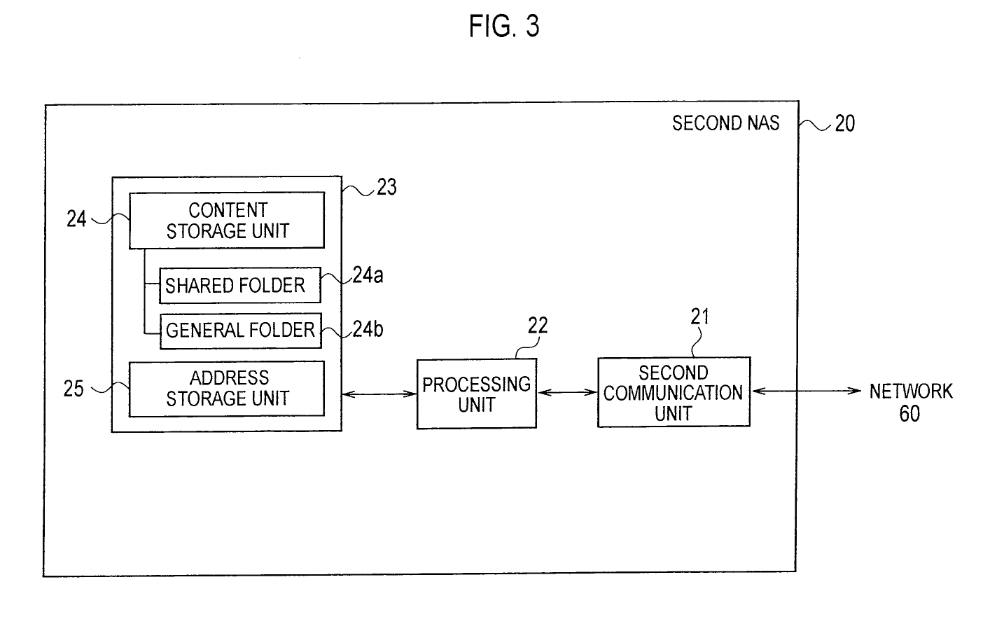

FIG. 3 is a configuration diagram of the second NAS 20 as a partner storage. It is noted that in the second NAS 20, the explanation of a configuration that is similar to that of the first NAS 10 but differs only in reference numeral will be omitted. The second NAS 20 includes a second communication unit 21, a processing unit 22, and a second storage unit 23.

The second communication unit 21 communicates data with the first NAS 10 via a network. The processing unit 22 executes a process in response to a request, etc., received from the first NAS 10 via the second communication unit 21. The processing unit 22 creates, for example, a second content list stored in the second storage unit 23, in response to a second list request via the second communication unit 21. The second storage unit 23 is a storage such as HDD in which predetermined information is stored.

(4) Configuration of Mobile Terminal 30

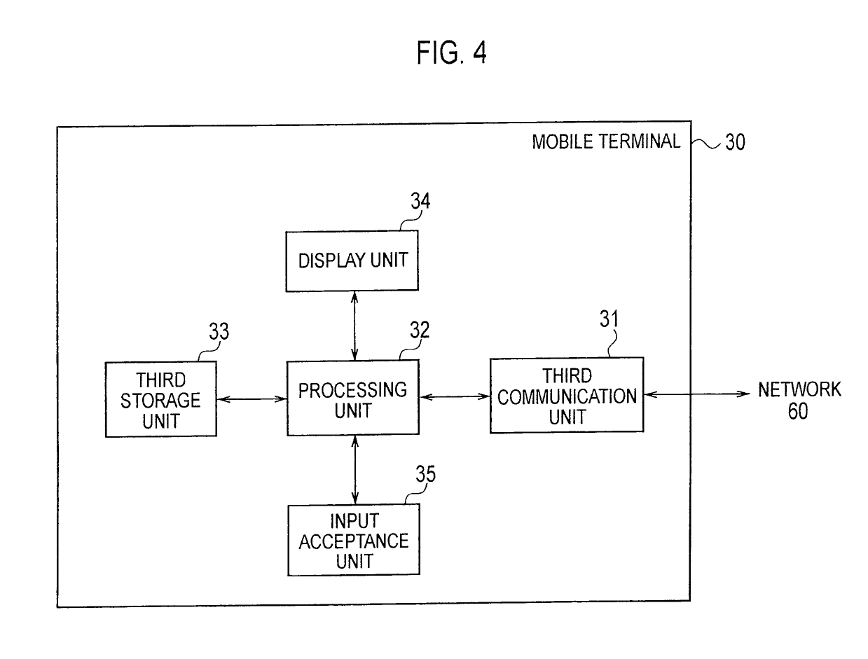

FIG. 4 is a configuration diagram of the mobile terminal 30 as client device. The mobile terminal 30 includes a third communication unit 31, a processing unit 32, a third storage unit 33, a display unit 34, and an input acceptance unit 35.

The third communication unit 31 is an interface for connecting the mobile terminal 30 to a base station (not shown). The mobile terminal 30 is connected to a network via the base station. This network includes a mobile telephone network and a gateway, and the mobile terminal 30 may be connected to WAN via the mobile telephone network, etc.

The processing unit 32 executes a process in response to information acquired via the third communication unit 31 and a request accepted by the input acceptance unit, for example. Specifically, after acquiring the first content list and the second content list from the third communication unit 31, the processing unit 32 stores the acquired information in the third storage unit 33 and displays the acquired information on the display unit 34. Moreover, the processing unit 32 creates, for example, a replica request in which the transmission-target information and the transmission-source information are included, in response to an input operation from a user.

The third storage unit 33 is a storage such as HDD in which predetermined information is stored. The third storage unit 33 stores a first content list and a second content list acquired via the management server 40.

The display unit 34 displays the first content list and the second content list received via the third communication unit 31. The display unit 34 displays a content such as video content stored in the third storage unit 33.

The input acceptance unit 35 includes a button, a touch panel, etc., and accepts an input instruction from a user. Specifically, the input acceptance unit 35 accepts a first list request and a second list request from a user, or accepts the selection of a transmission target and the selection of a transmission source based on the first content list and the second content list displayed on the display unit 34.

(5) Configuration of Management Server 40

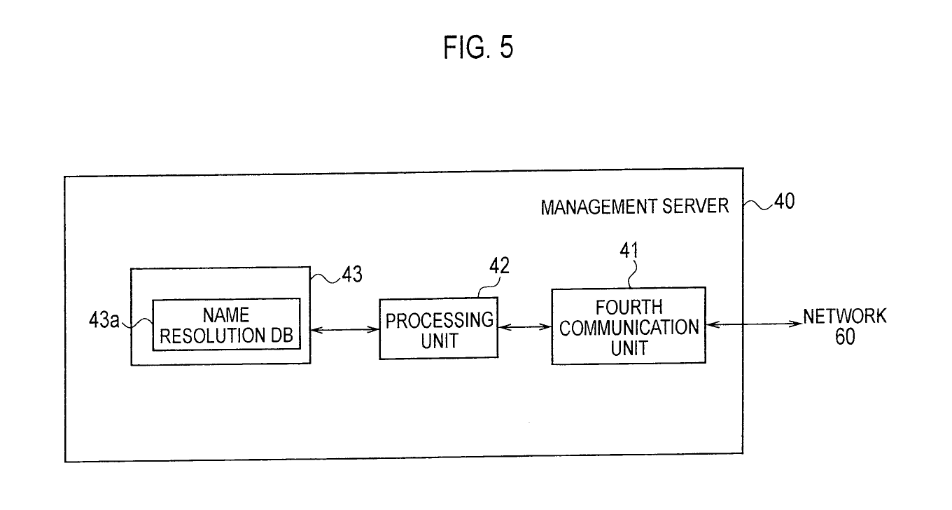

FIG. 5 is a configuration diagram of the management server 40 or name resolution server. The management server 40 includes a fourth communication unit 41, a processing unit 42, and a fourth storage unit 43.

The fourth communication unit 41 is an interface for connecting the management server 40 to WAN. The processing unit 42 executes a process in response to a request received from the mobile terminal 30, the first NAS 10, and the second NAS 20 via the fourth communication unit 41. For example, the processing unit 42 extracts the IP address of the corresponding NAS, in response to a name resolution request, and provides the content list of each NAS to the mobile terminal 30 after acquiring a Web access request from the mobile terminal 30 to the first NAS 10, etc.

The fourth storage unit 43 is a storage such as HDD in which predetermined information is stored. The fourth storage unit 43 includes a name resolution database 43a. In the name resolution database 43a, the device names of NAS's and their IP addresses or identification information are recorded in an associated manner.

Although not shown, the first NAS 10, the second NAS 20, the mobile terminal 30, and the management server 40 may include a program holding unit for holding a program that causes each communication unit, processing unit, and storage unit to execute a process through a PC. Examples of the program holding unit include recording media such as RAM, ROM, a hard disk, a flexible disk, a compact disk, an IC chip, and a cassette tape.

(6) Content Transmission Method

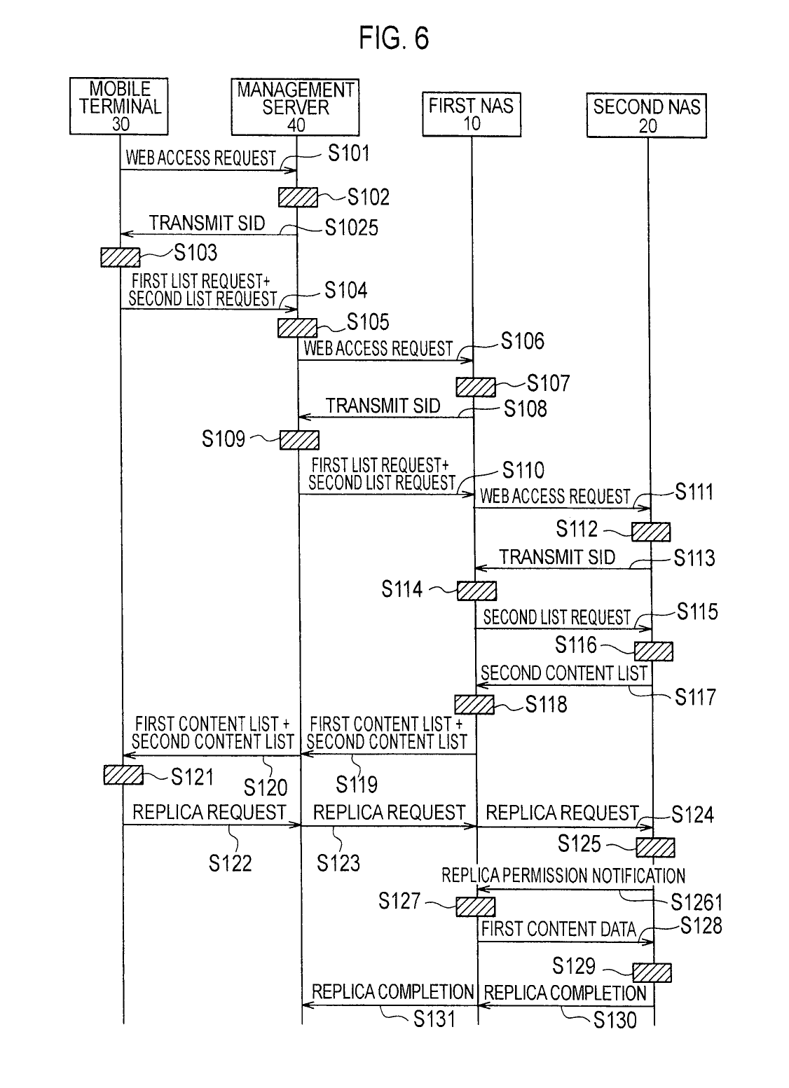

The content transmission method according to the first embodiment will be described with reference to FIG. 6. FIG. 6 is a sequence chart illustrating an operation of the content transmission system when the first content data that has been stored in the first NAS 10 is replicated in the second NAS 20.

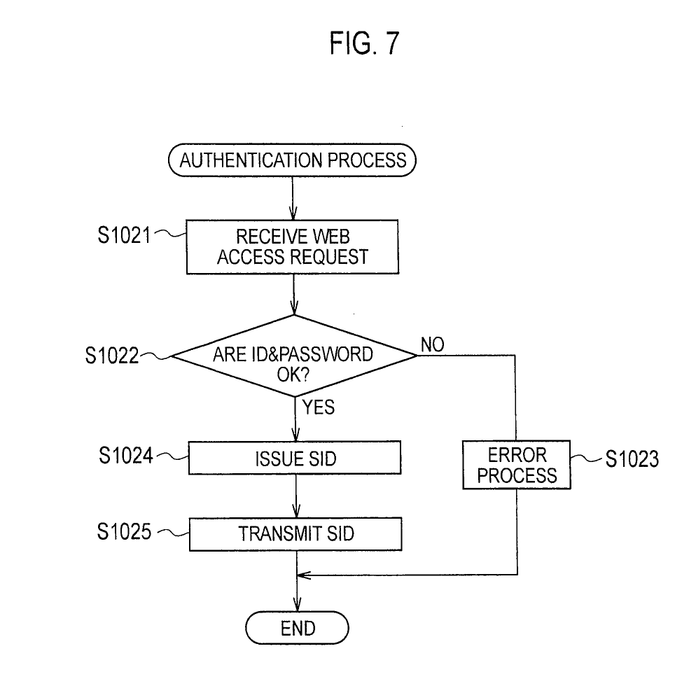

In S101, the mobile terminal 30 transmits the Web access request to the management server 40. Specifically, the mobile terminal 30 transmits an ID and a password to the management server 40. Subsequently, the management server 40 executes the authentication process (S102). FIG. 7 is a flowchart of the authentication process executed in the management server 40.

The management server 40 receives the ID and the password (S1021), and performs the authentication process for the ID and the password (S1022). When NO path is selected in S 1022, an error process is executed regarding that it is not possible to authenticate the ID and the password (S1023).

The error process is, for example, to transmit a message prompting the mobile terminal to retransmit the ID, etc. On the other hand, when YES path is taken in S1022, a security identifier (SID) is issued (S1024).

Subsequently, the management server 40 transmits the SID to the mobile terminal 30 (S1025). The mobile terminal 30 stores the received SID in the storage unit, after the reception of the SID from the management server 40 (S103). Thus, the authentication process is completed.

Subsequently, the mobile terminal 30 transmits the first list request and the second list request to the management server 40 (S104). Specifically, the mobile terminal 30 transmits the first list request and the second list request including the device names of the first NAS 10 and the second NAS 20 and the SID.

It is noted that according to this embodiment the SID may be invalidated after a lapse of a certain time period from a viewpoint of security. With such a design, when the management server 40 cannot authenticate, for example, as when the validity period of the SID included in the list request from the mobile terminal 30 expires, the authentication process can be automatically executed again. When the authentication process is automatically executed again, it is possible to simplify the operation by the user, and it is possible to realize a prompt process.

The management server 40 stores the device name of each NAS and the IP address in an associated manner, and extracts the IP address of the NAS (in this case the first NAS 10) corresponding to the device name subject to connection (S105). Then, the management server 40 transmits the Web access request to the first NAS 10 so that the first content list and the second content list can be acquired via the first NAS 10.

It is noted that the authentication process for the Web access request from the management server 40 (S107 to S109) is similar to the aforementioned authentication process between the management server 40 and the mobile terminal 30, and thus, the description is omitted. The management server 40 transmits the first list request and the second list request to the first NAS 10 after the authentication process (S110).

Subsequently, the first NAS 10 transmits the Web access request to the second NAS 20 in order to transmit the second list request to the second NAS 20 (S111). It is noted that authentication processes (from S112 to S114) are similar to the aforementioned authentication process, and thus, the description is omitted. The first NAS 10 transmits the second list request to the second NAS 20 after the authentication process (S115). In this second list request, the SID acquired by the first NAS 10 in the authentication process for the second NAS 20 is included.

The second NAS 20 determines whether or not the first NAS 10 is permitted to access the folder in which the content is stored, based on SID, in response to the reception of the second list request (S116). When NO is determined in S116, i.e., when the first NAS 10 is not permitted to access the corresponding folder, the error process is executed. On the other hand, when YES is determined in S116, the second content list or list of contents within the shared folder is transmitted to the first NAS 10 (S117).

The first NAS 10 creates the first content list stored in the shared list of the first NAS 10 (S118), and transmits the first content list and the second content list to the management server 40 (S119). The management server 40 transmits the first content list and the second content list to the mobile terminal 30 (S120). The mobile terminal 30 displays the first content list and the second content list, and accepts the selection input of the replicated content data for the first NAS (S121).

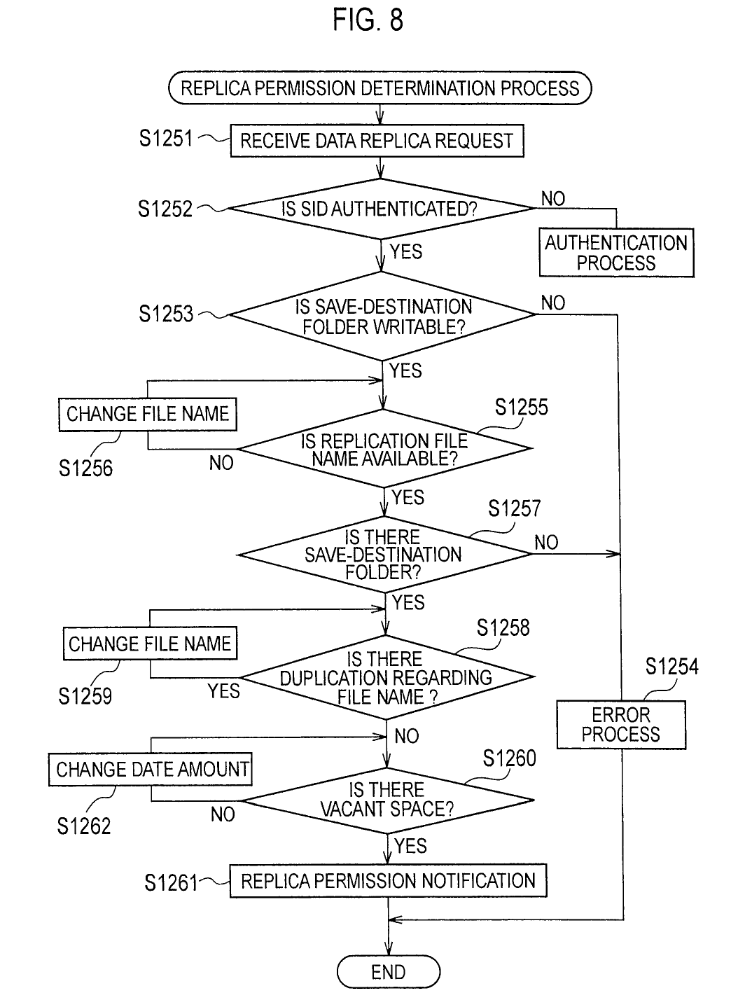

Subsequently, the mobile terminal 30 transmits the replica request including the replica-target information and the transmission-source information indicating the selected content, to the management server 40 (S122). The management server 40 transmits the replica request to the first NAS 10 (S123). The first NAS 10 transmits the replica request to the second NAS 20 (S124). The second NAS 20 executes a replica permission determination process of determining whether or not the replication is permitted, in response to the reception of the replica request (S125). FIG. 8 is a flowchart of the replica permission determination process executed in the second NAS. It is noted that the replica permission determination process is executed by the NAS which receives (stores)) the replica content data.

Upon receiving the data replica request (S1251), the second NAS 20 authenticates the SID (S1252). When NO is determined in S1252, for example, as when the validity period of the SID is expired or when the SID that has been issued in the preceding step is not coincident, the authentication process from S112 to S114 is executed again.

The authentication of the SID may be always executed whenever a request (the replica request or the list request) from another device is received. For example, the authentication of the SID may be executed in order to confirm that the request is transmitted from a device having the authority only when a change is applied to the device that has received the request as when the request is the replica request and the data is received (data is written).

When NO is determined in S1252, the fact that the SID was not authenticated may be displayed on the mobile terminal 30 via the first NAS 10, etc., and the authentication process may be executed again in response to a user operation. However, when the authentication process of the SID fails, if the authentication process is automatically executed again, then it is possible to alleviate operation load on the user and realize a prompt process.

On the other hand, when YES is determined in S1252, it is determined whether or not it is possible to store the replica content in a destination which is designated in the transmission-target information (S1253). The reason for this is that when the destination which is designated as storing the transmission-target information does not permit writing (browse only), for example, it is not possible to store the first content data received from the first NAS 10. When NO is determined in S1253, the error process to cancel the replication process is executed (S1254), and then, the replica permission determination process ends.

On the other hand, when YES is determined in S1253, it is determined whether or not the file name of the first content to be replicated is available (S1255). For example, when a character, a symbol, etc., that cannot be used as a file name are included in the file name, it is determined that the file name is not available. When NO is determined in S1255, the file name is changed (S1256). For example, the symbol, etc., that cannot be used are deleted.

On the other hand, when YES is determined in S1255, it is determined whether or not there is a destination folder which is designated as storing the transmission-target information (S1257). The reason for this is that the destination folder is designated by the mobile terminal 30, and when there is no designated destination, for example, it is not possible to store the first content to be replicated. When NO is determined in S1257, the error process is executed (S1254).

On the other hand, when YES is determined in S1257, it is checked whether or not there is a duplication regarding the file name of the destination folder (S1258). When YES is determined in S1258, i.e., when there is the same file name, the file name to be uploaded to the second NAS 20 is changed (S1259).

On the other hand, when NO is determined in S1258, i.e., when there is no same file name in the destination folder, it is checked whether or not there is a vacant space large enough for the first content to be replicated in the destination folder (S1260).

When YES is determined in S1260, i.e., when there is a sufficient vacant space, a replica permission notification is transmitted to the first NAS (S1261). On the other hand, when NO is determined in S1260, i.e., when there is not a sufficient vacant space, the data amount of the first content to be replicated is changed (S1262).

For example, the change is made so that a content capable of being accommodated in the available space can be replicated. This data amount change, together with a replica completion notification described later, may be notified to the user. Thus, the replica permission determination process is completed.

The first NAS 10 creates the first content data to be replicated based on the transmission-source information, in response to the reception of the replica permission notification from the second NAS 20 (S127), and transmits the first content data to the first NAS 10 (S128). The second NAS 20 stores the first content data received from the first NAS 10 in its storage folder (S129). Subsequently, the second NAS 20 transmits the replica completion report to the first NAS 10 (S130), and the first NAS 10 transmits the replica completion report to the management server 40 (S131). Thus, the first content data can be replicated in the second NAS 20.

In the present embodiment, the first NAS 10 transmits the first content data to be replicated to the second NAS 20 in response to the reception of the replica permission notification. Alternatively, however, the management server 40 may transmit the replica permission notification to the mobile terminal 30 in response to the reception of the replica permission notification, and may also transmit, in response to the issuance of a replica execution request from the mobile terminal 30, the first content data to be replicated to the second NAS 20. If it is made possible to accept the replica execution request from the mobile terminal 30, the operator of the mobile terminal 30 can understand that replication is permitted, and also the operator can understand that replication is executed by transmitting the replica execution request. For example, when the size of the content data to be replicated is large, there is no need for the operator to monitor the process of the replica data transmission process that takes more time than the replica permission determination process, and thus, it is possible to shorten the time required for the process by the operator. Moreover, as in the present embodiment, if the content data to be replicated is transmitted to the second NAS 20 in response to the reception of the replica permission notification, and if the notification is transmitted to the operator only when replication is not permitted, then it is possible to alleviate the operation load on the operator when replication is executed.

Moreover, the management server 40 may transmit the replica completion report to the mobile terminal 30 in response to the reception of the replica completion report, or the management server 40 may transmit the replica completion report to the mobile terminal 30 when the management server 40 is accessed by the mobile terminal 30 next time instead of transmitting the replica completion report to the mobile terminal 30 in response to the reception of the replica completion report.

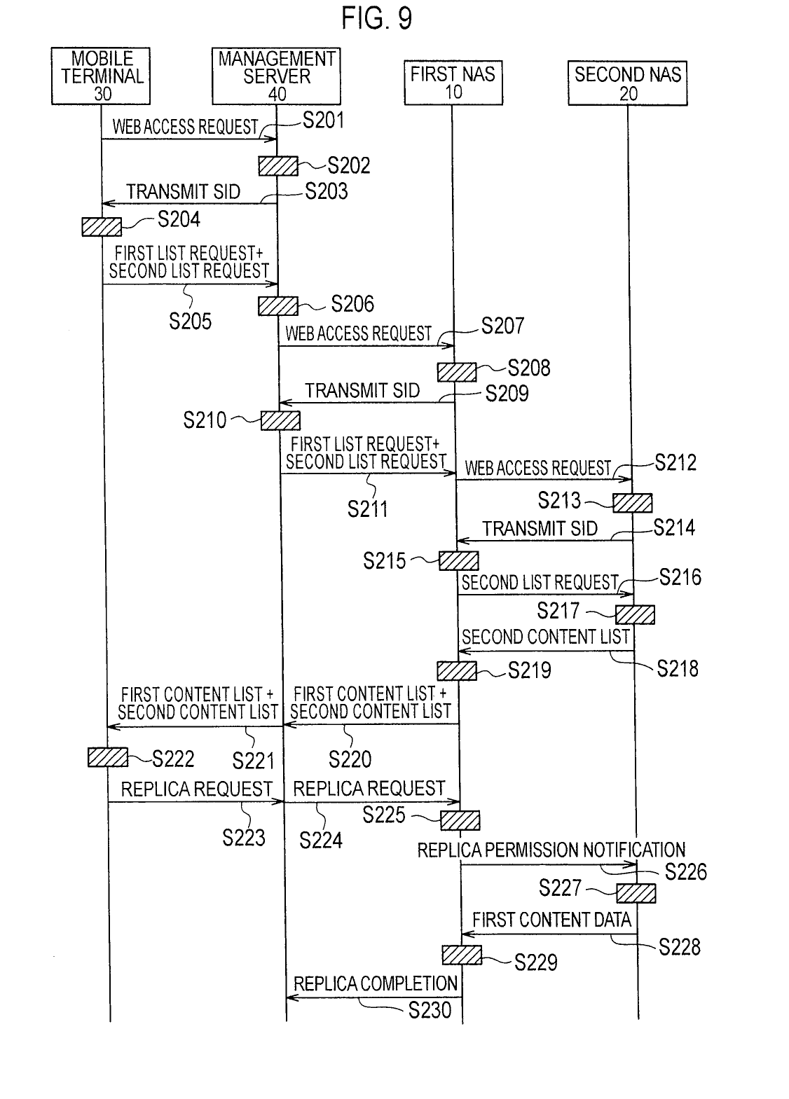

Subsequently, the content transmission method will be described in reference to FIG. 9, in the case where the content data of the second NAS 20 is replicated in the first NAS 10. FIG. 9 is a sequence chart illustrating the operation of the content transmission system when the content of the second NAS 20 is replicated in the first NAS 10. In the content transmission method illustrated in FIG. 9, the explanation of steps similar to those employed in the content transmission method illustrated in FIG. 6 will be omitted.

Processes from S201 to S224 illustrated in FIG. 9 are similar to those from S101 to S123 illustrated in FIG. 6.

Subsequently, in S225, the first NAS 10 executes the replica permission determination process, in response to the reception of the replica request from the management server 40. Specifically, it is checked whether or not the content to be replicated can be stored in the destination which is designated by the transmission-target information, whether or not the file name of the content to be replicated is available, whether or not the destination folder designated as the transmission-target information exists, whether or not there is more than one file having the same file name in the destination folder, and whether or not the destination folder has a vacant space large enough for the replica content.

The first NAS 10 transmits the replica permission notification to the second NAS 20 when the first NAS 10 determines that the downloading of the second content data to be replicated is permitted (S226). The second NAS 20 creates the second content data transmitted to the first NAS 10 based on the transmission-source information (S227), and transmits the second content data to the first NAS 10 (S228). The first NAS 10 stores the second content data received from the second NAS 20 (S229), and transmits the replica completion report to the management server 40 (S230).

According to the content transmission method, even if the mobile terminal 30 cannot access the second NAS 20, but if the mobile terminal 30 accesses the first NAS 10, the second content data from the second NAS 20 can be replicated in the first NAS 10, or the first content data from the first NAS 10 can be replicated in the second NAS 20.

Moreover, since the mobile terminal 30 does not need to relay the replica data, it is possible to shorten the time occupied by executing the replica request, and it is also possible to prevent the available drive time consumed by the mobile terminal 30 executing the replica request from being shortened.

Further, the mobile terminal 30 has only to be provided with the function of connecting to the management server 40 via a network and the function of accepting the data transmission request by displaying a content list, etc. Also, since the mobile terminal 30 does not need to include complicated functions, its versatility can be enhanced.

Furthermore, the storage unit may include a tree structure of data in which a plurality of items are hierarchized, a plurality of folders may be stored in the shared folder, and the contents may be stored in the lowest layer of the tree structure. In the case where the storage unit includes a tree structure in which a plurality of items are hierarchized, a low-level list serving as a list below the first content list and the second content list may be acquired. Specifically, for example, the first NAS and the second NAS transmit the folder lists within the shared folder to the mobile terminal in response to the first and second content list requests, and when the mobile terminal displays the folder list and accepts the folder selection input, the request for acquiring the content included in the corresponding folder is transmitted.

### Second Embodiment

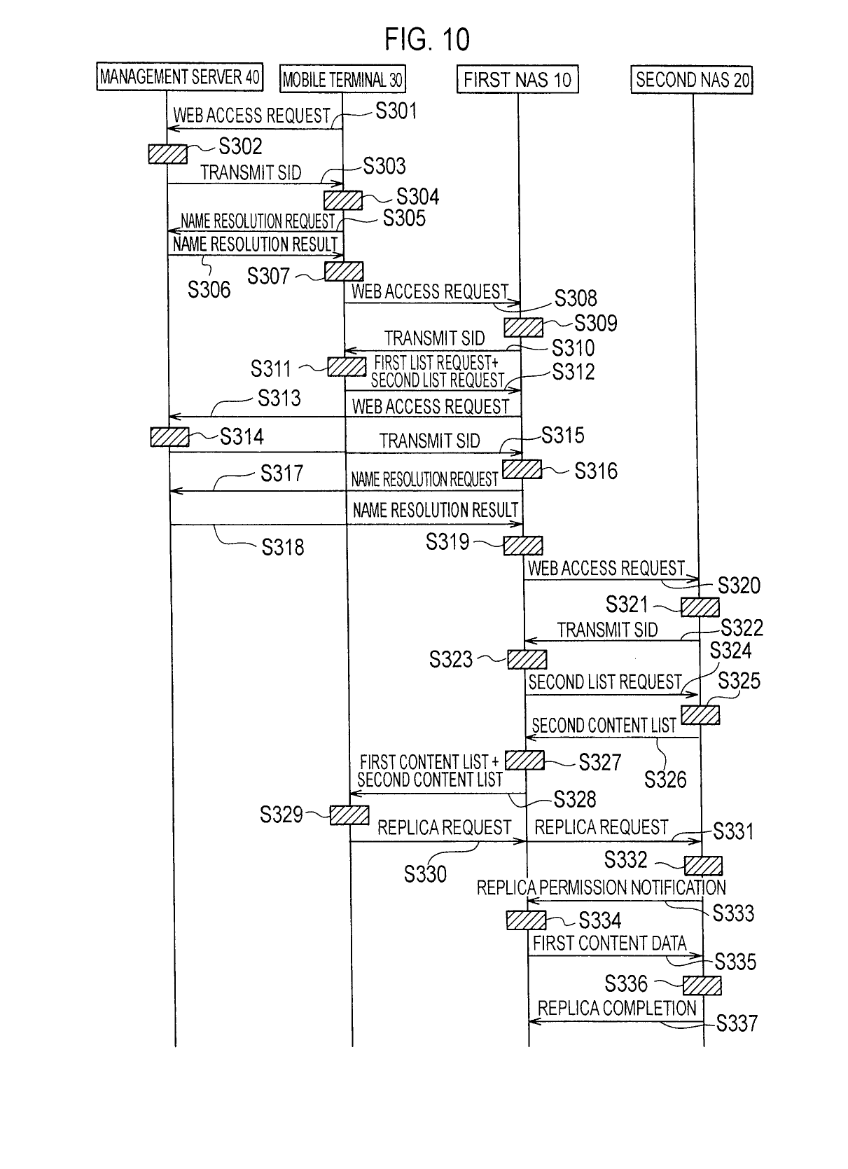

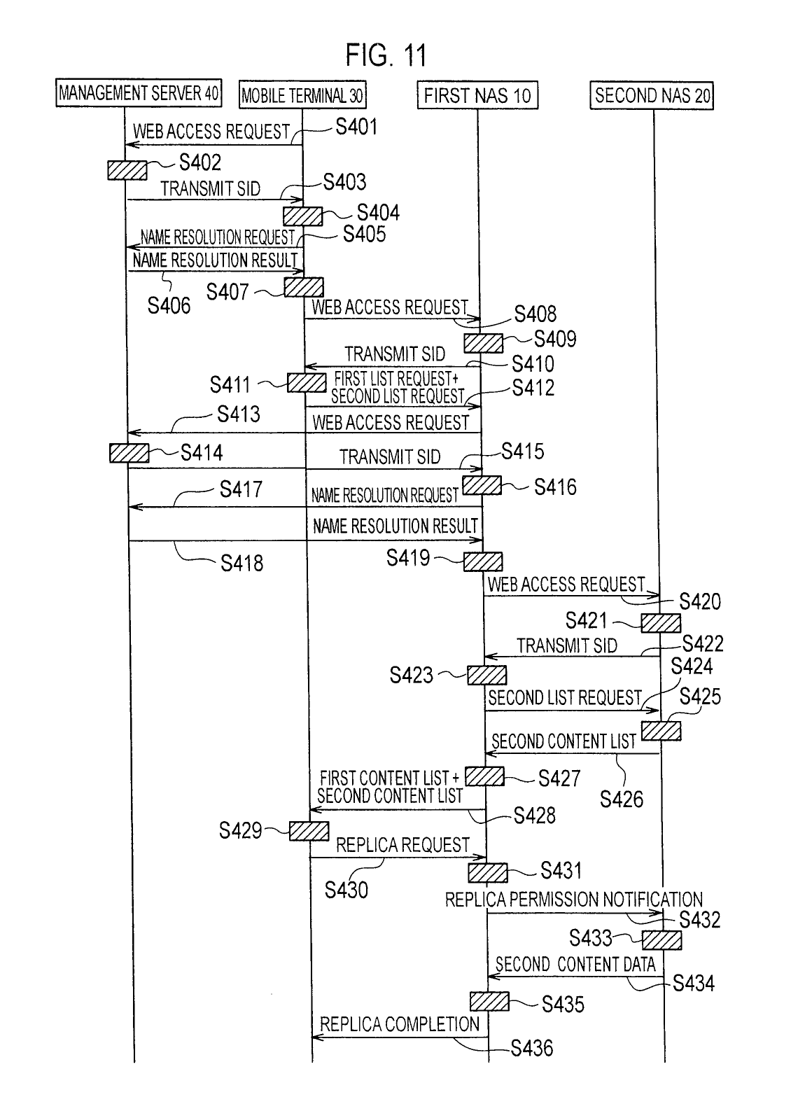

Subsequently, a content transmission method according to a second embodiment will be described. In the content transmission method according to the first embodiment, the list request from the mobile terminal 30 is transmitted to the first NAS 10 via the management server 40, but in the content transmission method according to the second embodiment, the list request from the mobile terminal 30 is directly transmitted to the first NAS 10 without the intervention of the management server 40. Subsequently, the content transmission method according to the second embodiment will be described with reference to FIG. 10 and FIG. 11. FIG. 10 and FIG. 11 are sequence charts illustrating an operation of the content transmission system when the management server 40 executes the name resolution of the first NAS 10 and the second NAS 20, in response to the list request from the mobile terminal 30. FIG. 10 is a sequence chart illustrating an operation of the content transmission system when the content in the first NAS 10 is replicated in the second NAS 20. FIG. 11 is a sequence chart illustrating an operation of the content transmission system when the content in the second NAS 20 is replicated in the first NAS 10. It is noted that in the content transmission method according to the second embodiment, the explanation of the processes similar to those in the first embodiment will be omitted.

The mobile terminal 30 transmits the Web access request to the management server 40 in order to transmit the name resolution request of the first NAS 10 to the management server 40 (S301). The authentication process for the Web access request (S302 to S304) is similar to the authentication process in the first embodiment, and thus, the description will be omitted. The mobile terminal 30 transmits the name resolution request of the first NAS 10 to the management server 40 after the authentication process (S305). Specifically, the device name of the first NAS 10 and the acquisition request of the IP address are transmitted. The management server 40 transmits the IP address serving as the name resolution result to the mobile terminal 30, in response to the name resolution request (S306). After receiving the IP address, the mobile terminal 30 stores the IP address of the first NAS 10 in a third storage unit 33 (S307). Subsequently, the mobile terminal 30 transmits the Web access request to the first NAS 10 in order to transmit the first list request and the second list request to the first NAS 10 (S308). Moreover, the authentication process for the Web access request (S309 to S311) is similar to the authentication process in the first embodiment, and thus, the description will be omitted. The mobile terminal 30 transmits the first list request and the second list request to the first NAS 10 after the authentication process (S312).

Subsequently, the first NAS 10 transmits the Web access request to the management server 40 in order to transmit the name resolution request of the second NAS 20 to the management server 40 (S313). It is noted that the authentication process for the Web access request (S314 to S316) is similar to the authentication process in the first embodiment, and thus, the description will be omitted. The first NAS 10 transmits the name resolution request of the second NAS 20 to the management server 40 after the authentication process (S317).

The management server 40 transmits the IP address of the second NAS 20, serving as the name resolution result, to the first NAS 10, in response to the name resolution request (S318). Upon receiving the IP address of the second NAS 20, the first NAS 10 stores the IP address of the second NAS 20 in the address storage unit 15 of the first storage unit 13 (S319).

The first NAS 10 transmits the Web access request to the second NAS 20 in order to transmit the second list request to the second NAS 20 (S320). It is noted that the authentication process for the Web access request (S321 to S323) is similar to the authentication process in the first embodiment, and thus, the description will be omitted. The first NAS 10 transmits the second list request to the second NAS 20 after the authentication process (S324).

The second NAS 20 creates the second content list as list of contents stored in the shared folder of the second NAS in response to the reception of the second list request (S325), and transmits the second content list to the first NAS 10 (S326). The first NAS 10 creates the first content list as list of contents stored in the shared folder of the first NAS 10 (S327). The first NAS 10 transmits the first content list and the second content list to the mobile terminal 30 (S328).

Subsequently, the mobile terminal 30 displays the first content list and the second content list received from the first NAS 10, and accepts the input of the replica request from the user (S329). The mobile terminal 30 transmits the replica request including the selected transmission-source information and transmission-target information, to the first NAS 10 (S330). By executing the following processes from S331 to S337, the first content data in the first NAS 10 can be replicated in the second NAS 20. It is noted that processes from S331 to S337 are similar to those from S124 to S130 in the first embodiment, and thus, the description will be omitted. As a result of the above processes, the second content data in the second NAS 20 can be replicated in the first NAS 10.

Subsequently, the content transmission method when the second content data is replicated in the first NAS 10 will be described with reference to FIG. 11. In the content transmission method illustrated in FIG. 11, the explanation of items similar to those in the content transmission method illustrated in FIG. 10 will be omitted. Processes from S401 to S430 illustrated in FIG. 11 are similar to those from S301 to S330 illustrated in FIG. 10. Subsequently, in S431, the first NAS 10 executes the replica permission determination process, in response to the reception of the replica request from the management server 40. Specifically, it is checked whether or not the replica content can be stored in the destination which is designated by the transmission-target information, whether or not the file name of the replica content is available, whether or not the destination folder which is designated as the transmission-target information exists, whether or not there is no files having the same file name in the destination folder, and whether or not the destination folder has a enough vacant space for the replica content.

The first NAS 10 transmits the replica permission notification to the second NAS 20 when the first NAS 10 determines that the downloading of the replica content data is permitted (S432). The second NAS 20 creates the replica content data transmitted based on the transmission-source information (S433), and transmits the content data to the first NAS 10 (S434). The first NAS 10 stores the content data received from the second NAS 20 (S435). Subsequently, the first NAS 10 transmits the replica completion report to the management server 40 (S436). As a result of the above processes, the second content data can be replicated in the first NAS 10.

Thus, the name resolution of each NAS can be executed by the management server 40 serving as the name resolution server. By performing the name resolution process, even if each NAS has not acquired the IP address of another NAS, the direct transmission and reception of data can be performed, and thus the replication process between the NASs can be performed. The management server 40 executes the name resolution process only between the NASs, and does not relay the replica data nor the list request. Therefore, it is possible to alleviate the burden on the management server.

In the foregoing, the preferred embodiments of the present invention are described. However, the present invention is not limited thereto, and modifications and changes are possible in various ways within the scope of the gist of the present invention.

For example, in the second embodiment, the name resolution process of the first NAS 10 and the name resolution process of the second NAS 20 are separately processed; however, it may be configured such that the mobile terminal 30 transmits a plurality of device names to the name resolution server and simultaneously acquires a plurality of IP addresses. Moreover, in the first embodiment and the second embodiment, it is configured such that the first NAS simultaneously transmits the first content list and the second content list to the mobile terminal; however, instead of being limited to this configuration, it may be configured to separately transmit the first content list and the second content list to the mobile terminal. Further, in the embodiments, the mobile terminal is used as the client device; however, instead of the mobile terminal, it may be configured such that PC is used as the client device.

In the present embodiments, it is configured such that the first NAS 10 acquires the second content list in response to the second list request from the mobile terminal 30 or the management server 40; however, as another embodiment, it may be configured such that the second content list is acquired beforehand in the first NAS 10. In such a configuration, it may be configured such that the second content list is regularly updated in response to a lapse of a certain time, or the second content list is updated when the first content data is moved or replicated to the second NAS 20.

What is claimed is:

1. A content transmission method in which a partner storage connected to a connection-target storage via a network transmits content data to the connection-target storage connected to a client device via a network, comprising:
a step in which the client device transmits a partner list request requesting a partner content list that is a list of contents stored in the partner storage, to the connection-target storage;
a step in which the connection-target storage transmits the partner list request, to the partner storage;
a step in which the partner storage transmits the partner content list to the connection-target storage, in response to the partner list request;
a step in which the connection-target storage transmits the partner content list received from the partner storage, to the client device; and
a step in which the client device transmits a data transmission request including transmission-source information indicating a transmission source storing the content selected based on the partner content list, to the connection-target storage.

2. The content transmission method according to claim 1, comprising;
a step in which the client device transmits a connection-target list request requesting a connection-target content list that is a list of contents stored in the connection-target storage, to the connection-target storage;
a step in which the connection-target storage transmits the connection-target content list to the client device, in response to the connection-target list request; and
a step in which the client device transmits data transmission request including transmission-source information indicating a transmission source of the content selected based on the connection-target content list and transmission-target information indicating a destination for the content, to the connection-target storage.

3. The content transmission method according to claim 1, comprising:
a step in which the client device transmits a connection-target list request requesting a connection-target content list that is a list of contents stored in the connection-target storage and the partner list request, to the connection-target storage;
a step in which the connection-target storage transmits the partner content list received from the partner storage and the connection-target content list, to the client device, in response to the connection-target list request and the partner list request; and
a step in which the client device transmits a data transmission request including transmission source information indicating the transmission source of a content selected based on the connection-target content list and the partner content list, and transmission-target information indicating a destination for the content, to the connection-target storage.

4. The content transmission method according to claim 3, comprising: a step in which the partner storage designates a transmission target based on the transmission-target information and transmits the corresponding partner content data to the connection-target storage when a partner content in the partner storage is included in the transmission-source information.

5. The content transmission method according to claim 2, further comprising a step in which the connection-target storage designates a transmission target based on the transmission target information and transmits the corresponding connection-target content data to the partner storage, when a connection-target content stored in the connection-target storage is included in the transmission source information.

6. The content transmission method according to claim 4, wherein the connection-target storage stores the partner content data in the destination for content, based on the transmission-target information, when receiving the partner content data from the partner storage.

7. The content transmission method according to claim 5, wherein the partner storage stores the connection-target content data in the destination for content, based on the transmission-target information, when receiving the connection-target content data from the connection-target storage.

8. The content transmission method according to claim 1, comprising:
a step in which the connection-target storage transmits a name resolution request to acquire an address of the partner storage, to a name resolution server configured to execute a name resolution with the partner storage, in response to the partner list request; and
a step in which the name resolution server transmits the address of the partner storage as a name resolution result, to the connection-target storage, in response to the name resolution request.

9. A connection-target storage comprising:
a storage unit for storing therein a plurality of contents; and
a communication unit for communicating with a client device and a partner storage via a network,
wherein the communication unit receives a partner list request requesting a partner content list stored in the partner storage, from the client device; receives the partner content list from the partner storage, in response to the partner list request; transmits the partner content list to the client device; and receives a data transmission request including transmission-source information indicating a partner content selected based on the partner content list, from the client device.

10. The connection-target storage according to claim 9, wherein
the connection-target storage further comprises a processing unit for creating a connection-target content list stored in the connection-target storage, and
the communication unit receives the partner list request and a connection-target list request requesting the connection-target content list, from the client device, and transmits the connection content list and the partner content list, to the client device.

11. The connection-target storage according to claim 9 or 10, further comprising a record holding unit for temporarily recording the partner content list.

12. A content transmission program that causes a computer that can communicate with a partner storage and a client device via a network to function as:
list request reception means for receiving a partner list request requesting a partner content list stored in the partner storage, from the client device via a network;
list transmission and reception means for transmitting the partner list request to the partner storage, and for transmitting the partner content list received from the partner storage, to the client device; and
data transmission request reception means for receiving a data transmission request including information indicating a partner content selected based on the partner content list, from the client device.
